(19) United States
(12) Patent Application Publication
(10) Pub. No.: US 2016/0071177 A1
(43) Pub. Date: Mar. 10, 2016

(54) BUYER FOCUSED VEHICLE ACQUISITION SERVICE

(71) Applicant: DML Holding LLC, Kirkland, WA (US)

(72) Inventor: Berne Launay, Spokane, WA (US)

(21) Appl. No.: 14/476,956

(22) Filed: Sep. 4, 2014

(51) Int. Cl. G06Q 30/06

(52) U.S. Cl. CPC G06Q 30/0611

(57) ABSTRACT

Techniques for better connecting buyers and sellers to facilitate vehicle acquisitions are described. The techniques include tools to enable buyers to specify the types of vehicles the buyers are interested in acquiring and view offers from potential sellers that have viewed the requests of the buyers. The techniques also include tools to enable sellers to view sales leads for potential buyers and to notify buyers of their interest in offering a vehicle for acquisition. Further, the techniques include a variety of other tools to facilitate vehicle acquisitions.

### BACKGROUND

Many vehicles are sold and purchased through online sites or paper material in an advertisement manner, in which sellers create advertisements for buyers to search through to find vehicles. The sellers typically provide details about vehicles that they are interested in selling and purchase advertisements to have the vehicles listed through online or paper sources. The buyers can then search through the advertisements and contact sellers to test drive or purchase vehicles. This process of purchasing vehicles is often time consuming and creates frustrated buyers who are unable to find vehicles that suit their needs.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which techniques described herein may be implemented.

FIG. 2 illustrates an example lead creation interface to enable a buyer to create a sales lead for a vehicle or vehicle type.

FIG. 3 illustrates an example buyer notification interface to notify a buyer of potential sellers.

FIG. 4 illustrates an example alert creation interface to enable sellers to provide alert information regarding sales leads.

FIG. 5 illustrates an example search interface to enable sellers to search through sales leads.

FIG. 6 illustrates an example seller alert interface to notify a seller about a sales lead regarding a vehicle that is associated with the seller.

FIGS. 7A-7B illustrate an example process for employing the techniques described herein.

### DETAILED DESCRIPTION

As discussed above, current techniques for purchasing vehicles are often time consuming and frustrating. For example, a buyer may spend many hours searching through hundreds of vehicle advertisements of sellers to find one vehicle that satisfies the buyer's needs. As the number of vehicles being purchased increases, there is an increasing need to assist buyers and sellers in vehicle transactions.

This disclosure describes, in part, techniques for better connecting buyers and sellers to facilitate vehicle acquisitions. The techniques include tools to enable buyers to specify the types of vehicles the buyers are interested in acquiring and view offers from potential sellers that have viewed requests of the buyers. The techniques also include tools to enable sellers to view sales leads for potential buyers and to notify buyers of their interest in offering a vehicle for acquisition. Further, the techniques include a variety of other tools to facilitate vehicle acquisitions.

In some instances, the techniques are implemented by a vehicle acquisition service. The vehicle acquisition service may provide an interface to enable a buyer to specify a type of vehicle the buyer is interested in acquiring. The vehicle acquisition service may generate a lead record for the buyer from the specified information and make the lead record available for a predetermined period of time, such as a number of hours, days, etc. The buyer may be required to provide payment to use the vehicle acquisition service to find a potential seller.

During the predetermined period of time, the vehicle acquisition service may provide services to assist the buyer in acquiring a vehicle. In one example, the vehicle acquisition service may identify a seller that has previously indicated an interest in being notified about sales leads for a vehicle that the seller is offering for acquisition. Here, the seller may have provided alert information regarding sales leads about which the seller is interested in being notified. Upon identifying the buyer as satisfying the alert information, the vehicle acquisition service may provide a notification to the seller indicating that a potential buyer has been found. In another example, the vehicle acquisition service may enable sellers to search through sales leads of buyers and identify potential buyers for a vehicle of the seller. In either example, the seller may view information about a potential buyer and submit a request to contact the potential buyer. The seller may be required to provide payment to use the vehicle acquisition service. When a request from a seller has been submitted, the vehicle acquisition service may send a notification to the buyer regarding a potential seller. The buyer may then view information about the seller and contact the seller to potentially acquire the seller's vehicle.

One implementation of the techniques described herein may be understood in the context of the following illustrative and non-limiting example. Bob is interested in buying a vehicle. He interacts with a vehicle acquisition service via an online site to identify a type of vehicle that he is interested in purchasing. Bob specifies that he would like a used pickup truck with less than 100,000 miles and for less than $15,000. Bob submits his request to the vehicle acquisition service along with payment for using the service. The vehicle acquisition service generates a lead record for Bob that is made available for 72 hours. During this 72 hour period, the vehicle acquisition service may identify potential sellers of vehicles that satisfy Bob's request.

Meanwhile, Sally is interested in selling a used pickup truck. She interacts with the vehicle acquisition service via the online site to provide details about her pickup truck, namely that she is looking to sell a 2005 pickup truck with 95,000 miles for $13,000. Through the online site Sally specifies that she would like to be notified of potential buyers who are interested in purchasing the pickup truck.

Upon receiving the request from Bob, the vehicle acquisition service identifies Sally as satisfying Bob's request and provides an alert to Sally indicating that a potential buyer has been found. The alert also indicates the type of vehicle that Bob is looking for. Sally confirms that she would like to be put in contact with Bob and provides payment to notify Bob of her interest in selling a pickup truck. The vehicle acquisition service sends a notification to Bob that includes Sally's contact information. Bob is free to contact Sally to test drive and purchase the pickup truck.

In addition, another seller, Steve, is also interested in selling a pickup truck that meets Bob criteria. He utilizes the vehicle acquisition service to search through sales leads that are active (e.g., within a 72-hour window of being created). Steve provides search input via the online site and finds a sales lead for Bob. Knowing that he has a vehicle that satisfies Bob's request, Steve submits a request to be put in contact with Bob. Upon receiving Steve's request, the vehicle acquisition service sends a notification to Bob that includes Steve's contact information. Again, Bob is free to contact Steve to test drive and purchase the pickup truck.

In some instances, the techniques described herein may provide valuable tools to buyers and/or sellers of vehicles. Some of the techniques may function to connect a buyer with those sellers that have vehicles that are of interest to the buyer. In many instances, a buyer may control the transaction by requesting to be put in contact with sellers of vehicles that the buyer is interested in acquiring. This may ultimately increase buyer satisfaction. Further, some of the techniques may allow sellers to identify sales leads for vehicles they are offering for acquisition. This may accelerate the process of connecting a seller with a potential buyer.

As used herein, the term “vehicle” may generally represent any type of transportation machine or device. Example vehicles include bicycles, watercrafts (e.g., boats, ships, jet skis, etc.), aircrafts (e.g., airplanes), space crafts, motor or road vehicles, trains, and so on. Motor or road vehicles may include cars, trucks (e.g., pickups, semi-trailer trucks, tractor trucks, etc.), trailers, sport utility vehicles (SUVs), motorcycles, buses, all-terrain vehicles (ATVs), utility terrain vehicles (UTVs), snowmobiles, recreational vehicles (RVs), heavy equipment vehicles (e.g., constructions equipment), off-road vehicles, and so on.

Although many of the techniques are discussed herein in context of vehicles, these techniques may be implemented in other contexts, such as real estate, a service or any item that is being offered for acquisition (e.g., digital items, devices, green energy devices, products, etc.).

This brief introduction is provided for the reader's convenience and is not intended to limit the scope of the claims. Furthermore, the techniques described in detail below may be implemented in a number of ways and in a number of contexts. Example implementations and contexts are provided with reference to the following figures, as described below in more detail. However, the following implementations and contexts are but some of many.

### Example Architecture

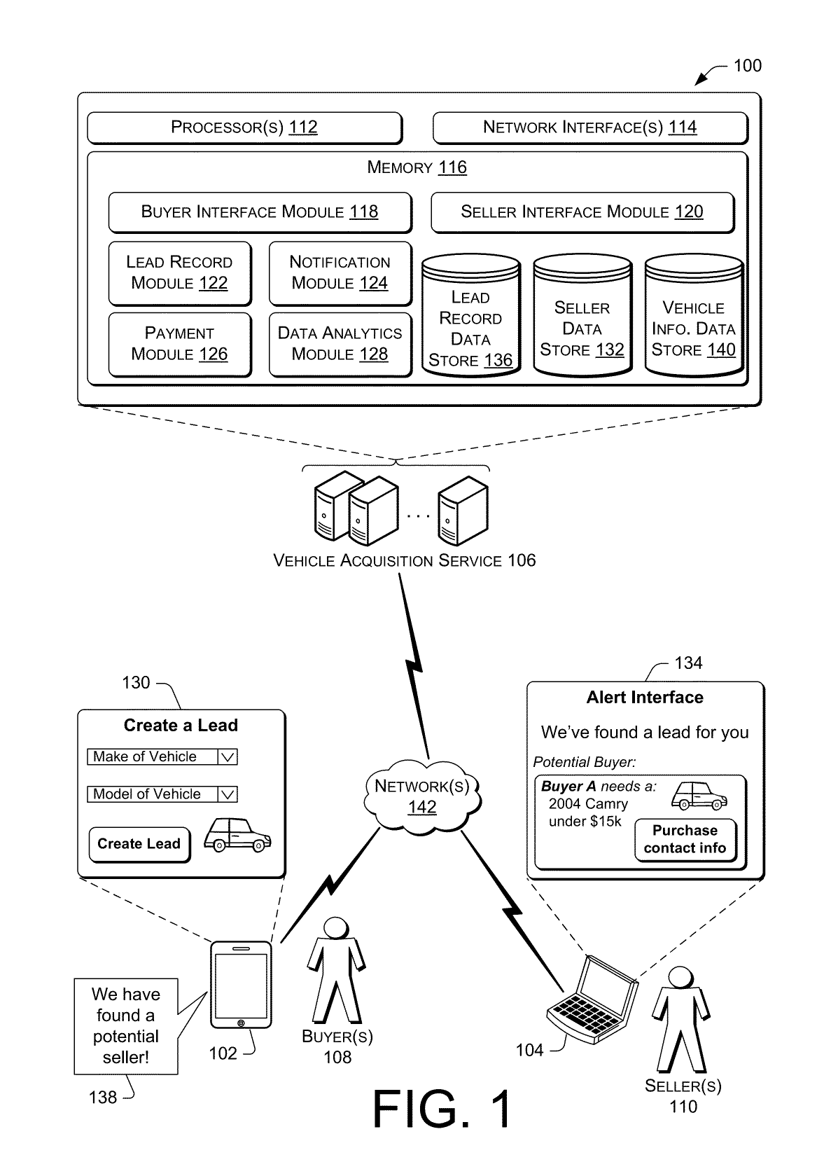

FIG. 1 illustrates an example architecture 100 in which techniques described herein may be implemented. The architecture 100 includes one or more buyer devices 102 (hereinafter “the buyer device 102”) and one or more seller devices 104 (hereinafter “the seller device 104”) configured to communicate with a vehicle acquisition service 106 to facilitate vehicle acquisitions between one or more buyers 108 (hereinafter “the buyer 108”) and one or more sellers 110 (hereinafter “the seller 110”). For example, the vehicle acquisition service 106 may connect buyers and sellers that are interested in acquiring or offering for acquisition the same types of vehicle. An acquisition of a vehicle may be achieved through purchasing, renting, borrowing, trading, bartering, or otherwise acquiring a vehicle. Although the buyer 108 and the seller 110 are illustrated as different individuals, a seller may be a buyer and a buyer may be a seller. That is, any user may be considered to be a buyer and/or a seller.

The buyer device 102 and/or the seller device 104 may comprise any type of computing device, such as a laptop computer, a desktop computer, a server, a smart phone, an electronic reader device, a mobile handset, a personal digital assistant (PDA), a portable navigation device, a portable gaming device, a tablet computer, a watch, a portable media player, a wearable computing device (e.g., a watch, an optical head-mounted display (OHMD), etc.), a television, a set-top box, a computer system in a vehicle, an appliance, a camera, a robot, a hologram system, a security system, a thermostat, a smoke detector, an intercom, a home media system, a lighting system, a heating, ventilation and air conditioning (HVAC) system, a home automation system (e.g., system to control a security system, a thermostat, a smoke detector, an intercom, a home media system, a lighting system, an HVAC system, etc.), a projector, an automated teller machine (ATM), and so on. In some instances herein, the buyer device 102 and/or the seller device 104 may be referred to as a mobile device, indicating that the respective device is portable.

The buyer device 102 and/or the seller device 104 may be equipped with one or more processors and memory communicatively coupled to the one or more processors. The one or more processors may include a central processing unit (CPU), a graphics processing unit (GPU), a microprocessor, a digital signal processor, and so on. The buyer device 102 and/or the seller device 104 may also include one or more components, such as a camera(s) (e.g., front facing and/or rear facing), a display(s), a microphone(s), a projector(s), a speaker(s), a sensor(s), a network interface(s), a scanner(s) (e.g., bar-code scanner, etc.), and so on. The one or more components may be communicatively coupled to the one or more processors. A display may include a touch screen, a Liquid-crystal Display (LCD), a Light-emitting Diode (LED) display, an organic LED display, a plasma display, an electronic paper display, or any other type of technology. A sensor may include an accelerometer, compass, gyroscope, magnetometer, Global Positioning System (GPS), olfactory sensor (e.g., for smell), or other sensor. The one or more components may be configured to receive user input, such as gesture input (e.g., through the camera), touch input, audio or speech input, and so on, and/or may be configured to output content, such as audio, images, video, and so on.

The vehicle acquisition service 106 may operation in cooperation with the buyer device 102 and/or the seller device 104 to facilitate vehicle acquisitions. The vehicle acquisition service 106 may include one or more computing devices, such as one or more desktop computers, laptop computers, servers, and the like. The one or more computing devices may be configured in a cluster, data center, cloud computing environment, or a combination thereof. In one example, the one or more computing devices provide cloud computing resources, including computational resources, storage resources, and the like, that operate remotely to the buyer device 102 and/or the seller device 104.

The one or more computing devices of the vehicle acquisition service 106 may include one or more processors 112, one or more network interfaces 114, and memory 116. The one or more processors 112, the one or more network interfaces 114, and/or the memory 116 may be communicatively coupled to each other. The memory 116 may include software functionality configured as one or more “modules.” The term “module” is intended to represent example divisions of the software for purposes of discussion, and is not intended to represent any type of requirement or required method, manner or organization. Accordingly, while various “modules” are discussed, their functionality and/or similar functionality could be arranged differently (e.g., combined into a fewer number of modules, broken into a larger number of modules, etc.). Further, while certain functions and modules are described herein as being implemented by software and/or firmware executable on a processor, in other embodiments, any or all of the modules may be implemented in whole or in part by hardware (e.g., as an ASIC, a specialized processing unit, etc.) to execute the described functions. As illustrated in FIG. 1, the memory 116 includes a buyer interface module 118, a seller interface module 120, a lead record module 122, a notification module 124, a payment module 126, and a data analytics module 128.

The buyer interface module 118 may provide buyer interfaces to assist buyers in acquiring a vehicle. For example, the buyer interface module 118 may cause a lead creation interface to be provided to enable a buyer to create a sales lead, which may be created in the form of a lead record as discussed below. Through the lead creation interface the buyer may input buyer vehicle information describing a type(s) of vehicle that the buyer is interested in acquiring. The type(s) of vehicle may be defined by ranges (e.g., a year range, price range, etc.), specific details (e.g., a particular engine type, such as a V8), or otherwise. Example buyer vehicle information may indicate:
a model of a vehicle in which a buyer is interested (e.g., Camry®, Ram truck 1500, Malibu car, etc.);
a manufacturing company of a vehicle in which a buyer is interested (e.g., Toyota®, Dodge®, Chevrolet®, etc.);
a color of a vehicle in which a buyer is interested;
engine details of a vehicle in which a buyer is interested (e.g., four cylinders, supercharged, fuel injected, etc.);
one or more years of a vehicle in which a buyer is interested (e.g., a year range, such as 1998-2006);
a price range of a vehicle in which a buyer is interested (e.g., $12,000-$15,000);
mileage of a vehicle in which a buyer is interested (e.g., less or more than 100,000 miles, between 50,000 and 75,000, etc.);
a body style of a vehicle in which a buyer is interested (e.g., truck, car, coupe, wagon, van, etc.); and/or
any other information that may identify a type of vehicle in which a buyer is interested.

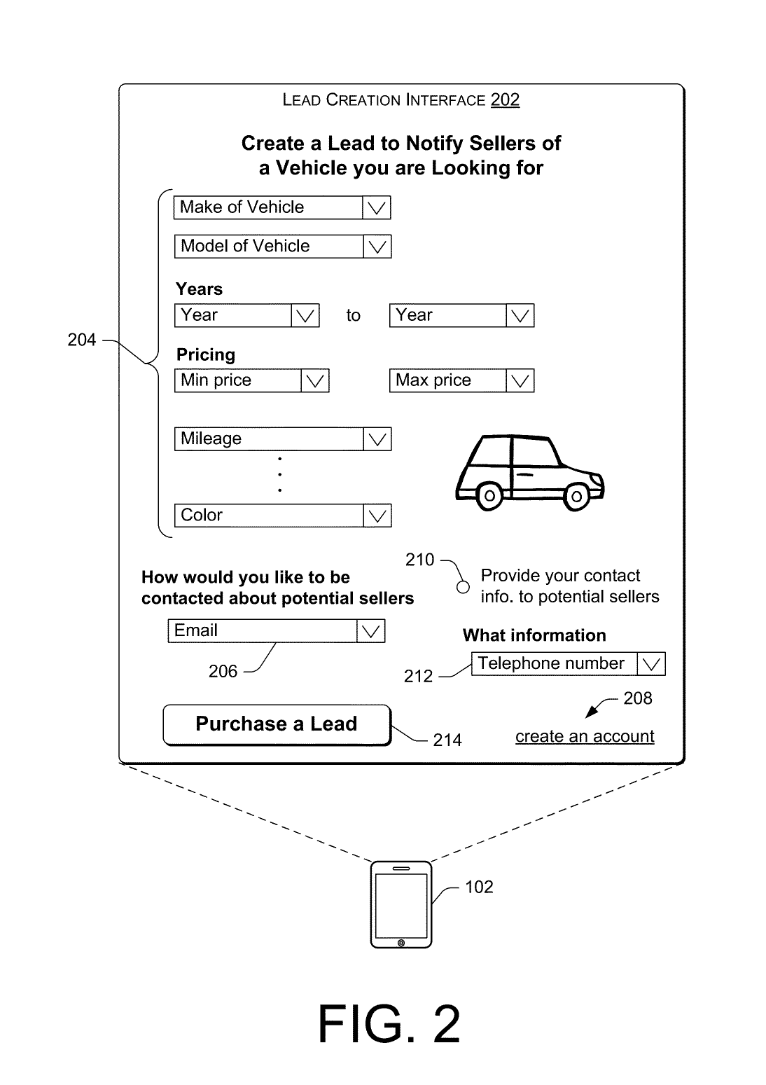

A lead creation interface may also enable a buyer to specify how communications to the buyer and/or a seller may occur. For example, the buyer may indicate a communication channel for being notified about potential sellers, such as email, telephone, text message, an interface (e.g., web interface, mobile application interface, etc.), and so on. In addition, the buyer may specify an amount of information about the buyer that may be provided to a potential seller. For example, the buyer may specify whether or not and/or how much contact information about the buyer may be provided to a potential seller so that the potential seller may contact the buyer. Contact information may include a telephone number, email address, mailing address, account name to a service (e.g., username to an instant messaging (IM) service), and so on. If a buyer indicates that a potential seller is not authorized to view any contact information about the buyer, the seller may merely submit a request to contact the buyer or initiate communication with the buyer in an anonymous manner (e.g., through a secure email system that does not reveal identifying information about individuals). FIG. 1 illustrates an example lead creation interface 130. A more detailed example lead creation interface is discussed below in reference to FIG. 2.

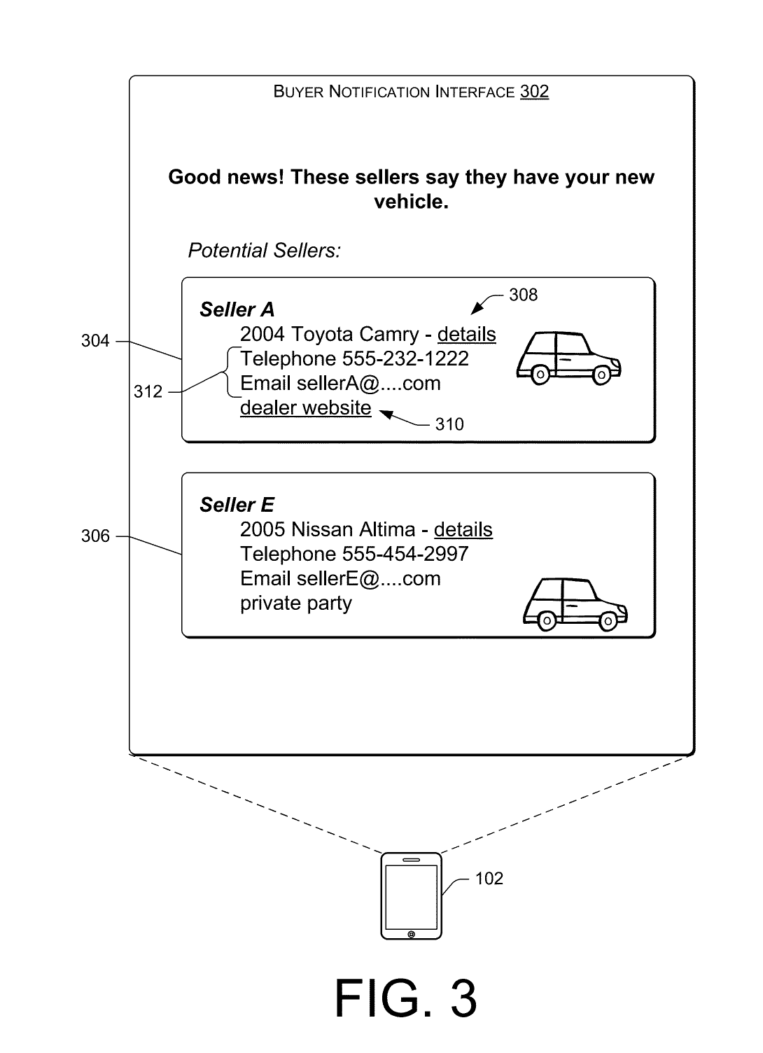

The buyer interface module 124 may also provide a notification interface to notify a buyer of potential sellers. The notification interface may identify sellers that have viewed information about the buyer and provided input indicating an interest in offering for acquisition a type of vehicle that the buyer is seeking. The notification interface may include contact information for a potential seller so that the buyer may contact the potential seller. An example notification interface that may be provided to a buyer is discussed below in reference to FIG. 3.

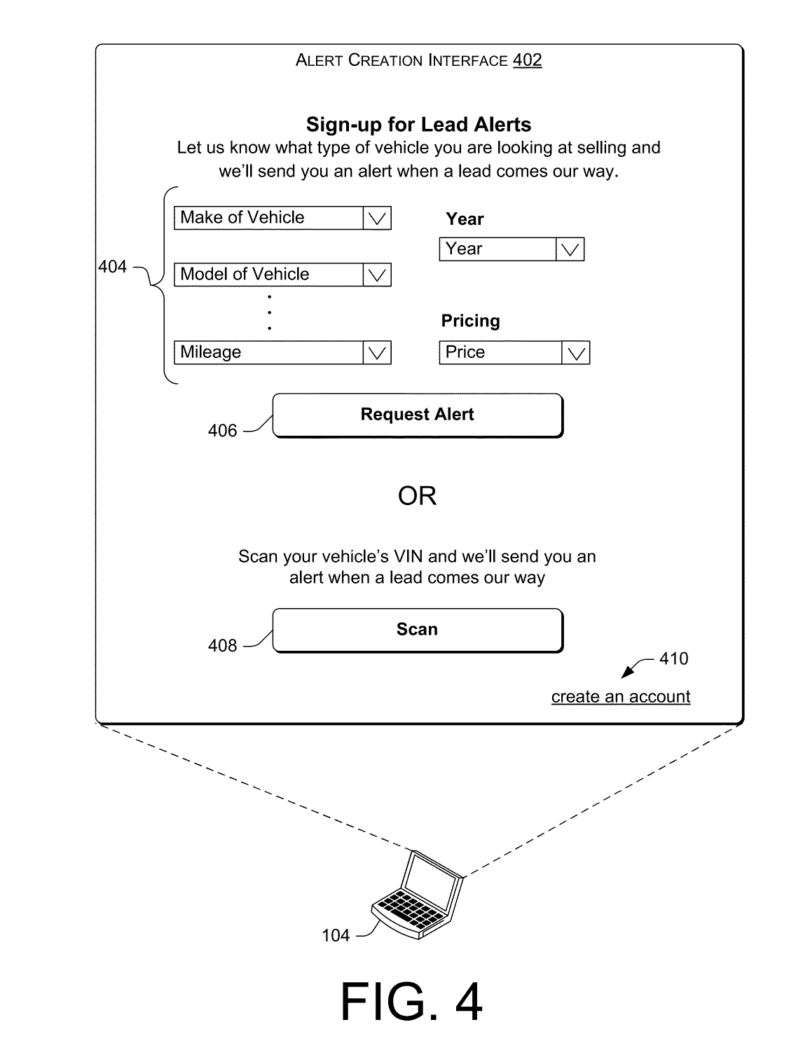

The seller interface module 120 may provide seller interfaces to assist in selling vehicles. For example, the seller interface module 120 may cause an alert creation interface to be provided to enable a seller to provide alert information regarding a sales lead(s) about which the seller is interested in being notified. In many instances, the alert information may describe a vehicle that the seller is interested in offering for acquisition to a buyer (e.g., a vehicle that the seller is in possession of). Although in other instances, the alert information may describe any vehicle or type of vehicle, even one that a seller is not in possession of Alert information may be stored in association to a seller that provided the alert information in a seller data store 132. FIG. 1 illustrates an example alert creation interface 134. A more detailed example alert creation interface is discussed in below in reference to FIG. 4. In some instances, alert information may be referred to as seller vehicle information. Example alert information may indicate:
a model of a vehicle for which a seller is interested in receiving a sales lead (e.g., Camry®, Ram truck 1500, Malibu car, etc.);
a manufacturing company of a vehicle for which a seller is interested in receiving a sales lead (e.g., Toyota®, Dodge®, Chevrolet®, etc.);
a color of a vehicle for which a seller is interested in receiving a sales lead;
engine details of a vehicle for which a seller is interested in receiving a sales lead (e.g., four cylinders, supercharged, fuel injected, etc.);
one or more years of a vehicle for which a seller is interested in receiving a sales lead (e.g., a year range, such as 1998-2006);
a price range of a vehicle for which a seller is interested in receiving a sales lead (e.g., $12,000-$15,000);
mileage of a vehicle for which a seller is interested in receiving a sales lead (e.g., less or more than 100,000 miles, between 50,000 and 75,000, etc.);
a body style of a vehicle for which a seller is interested in receiving a sales lead (e.g., truck, car, coupe, wagon, van, etc.); and/or
any other information that may identify a type of vehicle for which a seller is interested in receiving a sales lead.

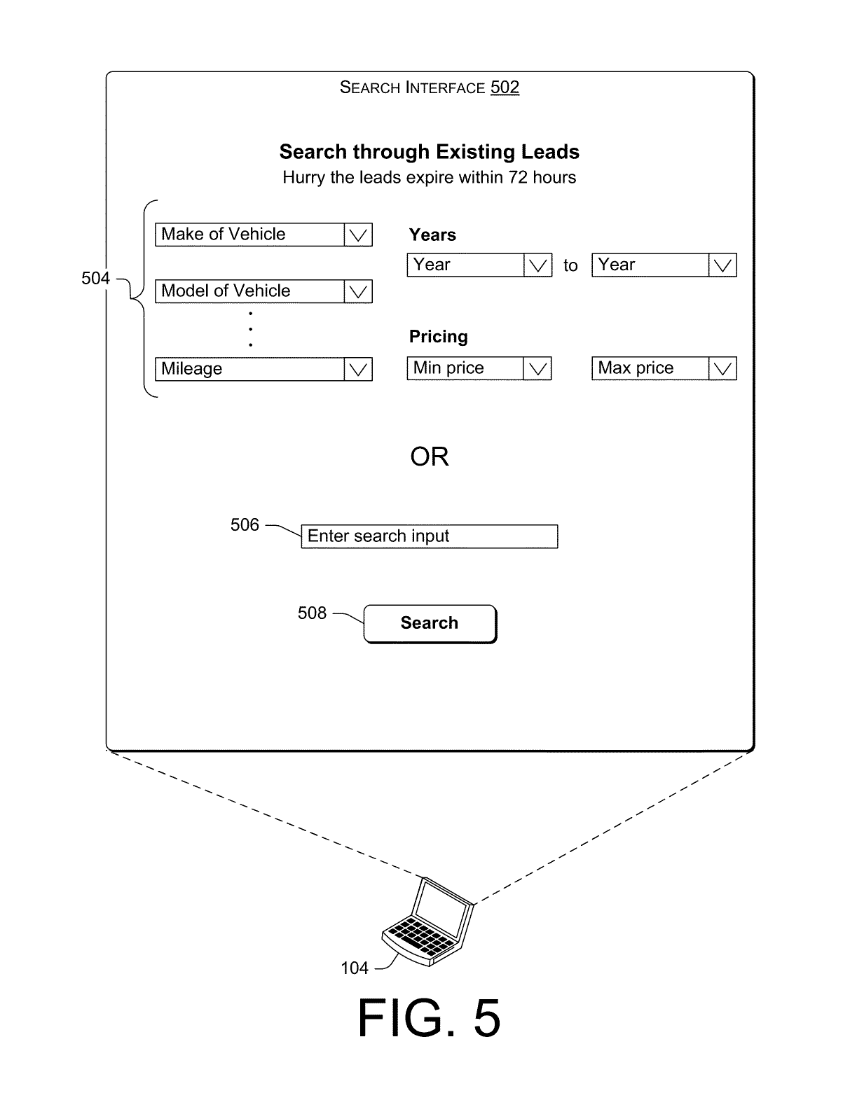

The seller interface module 126 may also provide a search interface to enable a seller to search through sales leads (e.g., lead records). Through the search interface the seller may provide input regarding a vehicle or type of vehicle, such as details about a vehicle that the seller is offering for acquisition (e.g., model, make, year, etc.). Sales leads that satisfy the search input may then be provided through an alert interface, as discussed below. An example search interface that may be provided to a seller is discussed below in reference to FIG. 5

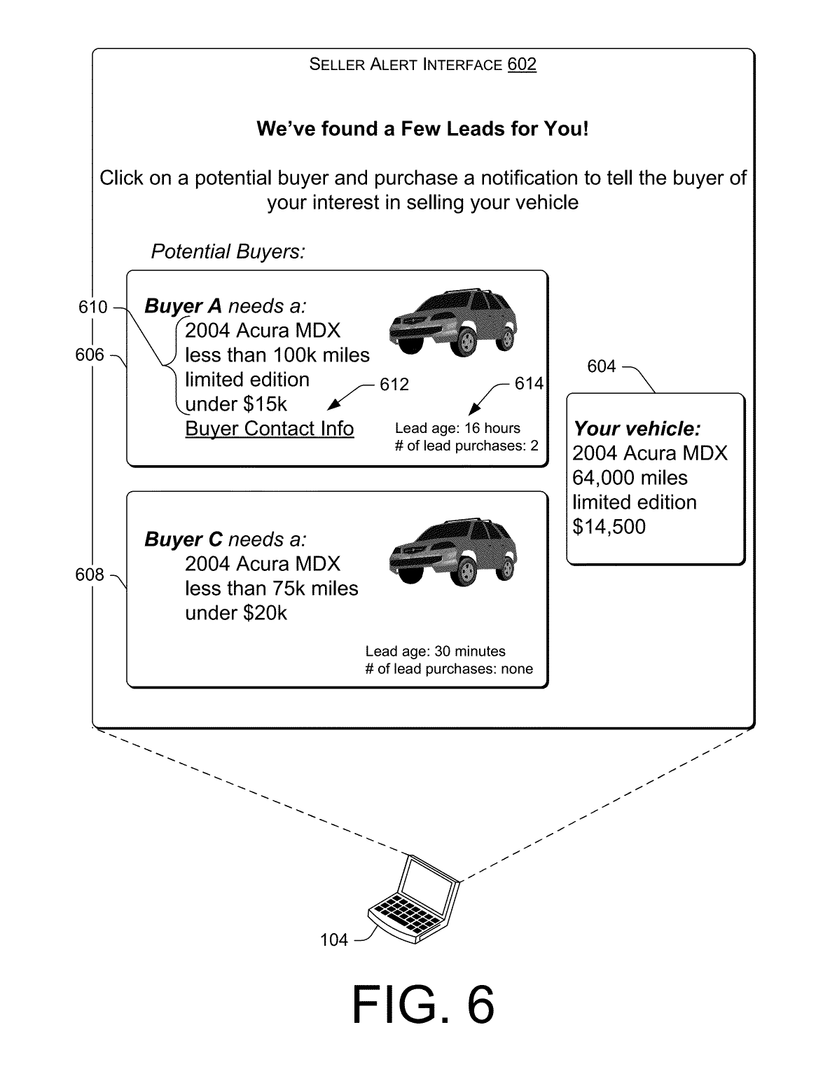

The seller interface module 126 may also provide an alert interface to notify a seller about sales leads for a vehicle associated with the seller. For example, the alert interface may include information about a vehicle that a buyer is seeking to acquire, such as buyer vehicle information, contact information for the buyer (if authorized to make available), etc. The alert interface may also provide information about how long a sales lead has been active (e.g., a lead age, indicating a number of hours that a lead has been active), a number of views of the sales lead, a number of purchases of the sales lead to contact the buyer, etc. The alert interface may be provided in response to identifying a sales lead that satisfies alert information for a seller (e.g., when a user logs into a site of the vehicle acquisition service 106) and/or in response to receiving search input from a seller. Through the alert interface the seller may select a potential buyer for the vehicle acquisition service 106 to contact. This may cause the buyer to be contacted. An example alert interface that may be provided to a seller is discussed below in reference to FIG. 6.

The lead record module 128 may utilize buyer vehicle information and/or other information that is provided by a buyer to generate a lead record for the buyer. A lead record may generally include buyer vehicle information and specify how communications to the buyer and a potential seller may occur and an amount of information about the buyer that may be provided to the potential seller. A lead record may generally represent a sales lead for a buyer that identifies a type of vehicle that a buyer is looking to acquire. To illustrate, a lead record for a user that would like to purchase a Toyota Camry® may specify that the user would like to purchase a used Camry® with less than 100,000 miles and for less than $12,000. The lead record may also specify that the user has a preference for a silver Camry® that is manufactured after 2006. Further, in this illustration, the lead read may also indicate that the user would like to be contacted through email and that only an email address of the user can be provided to a potential seller. Lead records may be stored in a buyer data lead record data store 136.

The lead record module 126 may utilize lead records to identify potential sellers. In some examples, the lead records may be compared to alert information of sellers to identify sellers to notify about sales leads. To illustrate, the lead record module 122 may determine whether alert information of a seller describes a vehicle that satisfies buyer vehicle information for a buyer. When such as match is found, the seller and/or buyer may be notified of an acquisition opportunity. In other examples, the lead record module 128 may determine whether search input from a seller describes a vehicle that satisfies buyer vehicle information for a buyer.

In many instances, the lead record module 126 may make a lead record available for a predetermined period of time, such as a number of hours, days, weeks, etc. In other words, the lead record may be utilized by the vehicle acquisition service 106 during the predetermined period of time. During the predetermined period of time, the vehicle acquisition service may identify potential sellers and/or make information available to buyers and/or seller regarding acquisition opportunities (e.g., send notifications/alerts).

The notification module 124 may notify buyers and/or sellers regarding vehicle acquisition opportunities. In some instances, the notification module 124 cause a notification to be made available through an interface, such as a buyer notification interface that presents potential sellers or a seller alert interface that presents potential buyers. In other instances, the notification module 124 may provide a notification about an acquisition opportunity to a buyer and/or seller by sending an email, sending a text message, initiating a telephone call (e.g., using a buyer's phone to call a seller's phone in response to the buyer selecting the seller), and so on. A notification to a buyer may be sent according to a communication channel that is specified by the buyer. FIG. 1 illustrates an example notification 138 that may be provided to notify the buyer 108 of a potential seller. In this example, the notification 138 is a pop-up window that appears on a screen of the buyer device 102.

The payment module 126 may facilitate payment from buyers and/or sellers for using the vehicle acquisition service 106. In one example, a buyer may provide payment to create a sales lead and the payment module 126 may wait to receive confirmation from a payment service (e.g., bank, online money transfer service, etc.) that the buyer has provided the payment. When the confirmation is received, a lead record for the buyer may be created or otherwise utilized by the vehicle acquisition service 106. In another example, a seller may provide payment to initiate communication with a buyer and the payment module 126 may wait to receive confirmation from a payment service that the payment was received. Upon receiving confirmation, a notification may be sent to the buyer regarding an acquisition opportunity.

The payment module 126 may also provide other processing to manage funds of a buyer and/or seller. In many instances, a sales lead may be available for a predetermined period of time with a particular payment amount or single payment. As such, a buyer may be given the opportunity to purchase additional time for the sales lead to remain active (e.g., may purchase a bundle of sales lead time periods upon initiating interaction with the vehicle acquisition service 106, may purchase additional time upon expiration of the predetermined period of time, etc.). The payment module 126 may identify how much payment has been provided and operate in cooperation with the lead record module 122 to evaluate whether a sales lead is expired (e.g., outside a period of time that has been paid for). The payment module 126 may also provide refunds and/or discounts if a buyer and/or seller is not notified about an acquisition opportunity. To illustrate, if a period of time that is paid for by a buyer expires and the buyer has not been notified of any potential sellers, then the buyer may receive a 50% discount to utilize the service again (e.g., repost a sales lead).

The data analytics module 128 may utilize sales information of vehicles that are acquired through the vehicle acquisition service 106 to generate acquisition metrics. The data analytics module 128 may track vehicle acquisitions by collecting data about sales leads that are created by buyers, alert information that is created by sellers, notifications that are sent to buyers and/or sellers, searches of sellers through sales leads, and so on. Further, in some instances the data analytics module 128 may receive input from buyers and/or sellers about when a vehicle is actually acquired, an acquisition price, and so on. The data analytics module 128 may collect data from individuals with the explicit authorization of the individuals and/or in an anonymous manner that removes information identifying the individuals. The collected data may represent sales information. Based on the sales information, the data analytics module 130 may generate an acquisition metric that may be provided to buyers, sellers, vehicle distributors, vehicle manufactures, and so on. In some instances, an acquisition metric is provided via one of the interfaces discussed below in reference to FIGS. 2-6. Example acquisition metrics include:
A peak or low time of the year, month, week, etc. that buyers are interested in acquiring vehicle (e.g., a peak—more than a threshold number of individuals create sales leads in the first half of September, low—less than a threshold number of individuals create sales leads in January);
A peak or low time of the year, month, week, etc. that sellers are interested in offering vehicles for acquisition (e.g., based on a when sellers request to be alerted about sales leads, when sellers search through sales leads, etc.);
A type of vehicle that is popular among buyers (e.g., a type of vehicle in which a predetermined number of buyers have indicated an interest based on sales leads that are created by the buyers)—in some examples, the type of vehicle may be specific to a particular geographical region (e.g., SUVs are popular in the northwest);
A typical price for a particular type of vehicle (e.g., a particular vehicle is sold at around $13,000);
A trend in vehicle acquisitions (e.g., this month has more than doubled the sales for last month)—in some examples, a trend may be provided in a graph form; or
Any other metric that may be derived from sales information.

As illustrated in FIG. 1, the vehicle acquisition service 106 may include a vehicle information data store 140 to store vehicle information for any number of vehicles. For example, the vehicle information data store 134 may store details about all vehicle makes and models that have been manufactured. The details may include any of the buyer vehicle information.

Although in the example architecture 100 of FIG. 1, the modules 118-128 and the data stores 132, 136 and 140 are illustrated as being included in the vehicle acquisition service 106, one or more of these elements may be included in the buyer device 102, the seller device 104, or elsewhere. As such, in some instances the vehicle acquisition service 106 may be eliminated entirely (e.g., when processing is performed locally on a device).

The memory 116 (as well as all other memory described herein, including the memory of the buyer device 102 and/or the seller device 104) may include one or a combination of computer storage media (e.g., computer-readable storage media). Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer storage media does not include communication media, such as modulated data signals and carrier waves. As such, computer storage media is limited to non-transitory media.

The architecture 100 may also include one or more networks 142 to enable the buyer device 102, the seller device 104, and/or the vehicle acquisition service 106 to communicate with each other. The one or more networks 142 may include any one or combination of multiple different types of networks, such as cellular networks, wireless networks, Local Area Networks (LANs), Wide Area Networks (WANs), and the Internet.

### Example Interfaces

FIGS. 2-6 illustrate example interfaces that may be presented to a user to facilitate the techniques discussed herein. The interfaces may be displayed via a browser, an application, and so forth. In some instances, an application is implemented as a client application, such as a mobile application, desktop-based application, etc. In other instances, the application is implemented as part of a platform (e.g., a mobile platform), or within another context. Although each interface is illustrated in FIGS. 2-6 as being presented to a particular party (either a buyer or a seller), each interface may be provided to a buyer, seller, or any other user.

FIG. 2 illustrates an example lead creation interface 202 to enable a buyer to create a sales lead for a vehicle or vehicle type. The lead creation interface 202 may include drop down menus 204 to enable the buyer to provide various details about a vehicle that the buyer is interested in acquiring. As illustrated, the buyer may select a make of a vehicle (e.g., manufacturer), model of a vehicle, years of a vehicle, minimum and maximum pricing, mileage, color, and so on. This input may be utilized to form buyer vehicle information and/or a lead record for the buyer.

The lead creation interface 202 also includes a drop down menu 206 to specify how the buyer would like to be contacted about potential sellers (e.g., email, telephone, text message, interface, etc.). In one example, the buyer may select to be notified via an interface, such as a web interface, mobile application interface, etc. Here, the buyer may create an account with the vehicle acquisition service 106 via a link 208. Thereafter, the buyer may log into the account and view information about potential sellers via a buyer notification interface. In another example, the buyer may specify to be notified via a text message and provide a telephone number at which to be notified. In yet another example, the buyer may provide an email address at which to be notified.

Further, the lead creation interface 202 may include a radio button 210 to specify whether or not contact information about the buyer may be provided to a potential seller. When the radio button 210 is enabled, the buyer may utilize a drop down menu 212 to select the types of contact information that may be provided to potential sellers. For example, the buyer may select an option to allow a telephone number, email address, mailing address, and/or account name to a service (e.g., username to an instant messaging (IM) service) to be made available to potential sellers.

Upon entering information in the lead creation interface 202, the buyer may select a button 214 to purchase a sales lead. A sales lead for the buyer may then be created based on the input information. In some instances, the buyer may be presented with a billing interface in response to selecting the button 214, so that the buyer can provide billing information to purchase the lead (e.g., credit card information, apply account funds, etc.).

FIG. 3 illustrates an example buyer notification interface 302 to notify a buyer of potential sellers. The buyer notification interface 302 may provide a list of vehicles that satisfy buyer vehicle information for the buyer. As illustrated, the list includes an offer 304 and an offer 306 from sellers that have indicated an interest in selling to the buyer. Although only two offers are illustrated in FIG. 3, any number of offers may be listed. Within the offer 304, the buyer may select a details link 308 to view details about the vehicle or select a website link 310 to navigate to a website of the seller. Here, the offer 304 also includes contact information 312 for Seller A. The buyer may contact the seller by selecting a telephone number or email address, which may initiate a telephone application or email application. The offer 306 includes similar features of a details link and contact information. As illustrated, the offer 304 is from a dealership, while the offer 306 is from a private party. In one example, the buyer notification interface 302 is provided via a mobile interface or web page.

FIG. 4 illustrates an example alert creation interface 402 to enable sellers to provide alert information regarding sales leads. The alert creation interface 402 may include drop down menus 404 to specify a vehicle about which the seller is interested in being notified. In many instances, the seller may specify details for a vehicle that the seller is offering for acquisition, so that the seller can receive sales leads for the vehicle. As illustrated, the drop down menus 404 may enable a seller to select a make of a vehicle, a model of a vehicle, mileage, year vehicle was manufactured, a price to sell the vehicle for, and so on. Although not illustrated in FIG. 4, in some instances the alert creation interface 402 may include other drop down menus to specify a range. For example, the alert creation interface 402 may include another drop down menu for a year, so that a start year and an end year may be specified (e.g., notify a seller of sales leads for buyers interested in vehicles that are made between 2004 and 2006). The alert creation interface 402 may also include a button 406 to submit a request for sales leads. Upon selecting the button 406, alert information may be formed for the seller.

The alert creation interface 402 may also include a button 408 to scan a vehicle identification number (VIN) or other information in order to identify a vehicle. Instead of entering information through the drop down menus 404, the seller may select the button 408 to utilize a camera or other device of the seller device 104 to capture an image of a VIN of a vehicle. The vehicle acquisition service 106 may utilize the VIN to identify the seller's vehicle and any details about the seller's vehicle (e.g., from the vehicle information data store 140). These details may be used to form alert information for the seller. This may be particularly useful when the seller device 104 is a mobile device. Although the alert creation interface 402 includes the scan button 408 in FIG. 4 to obtain a VIN, other information may be obtained. Further, the alert creation interface 402 may include an input field to provide any vehicle identification information. In addition, in some instances a seller may utilize the scan function to take a picture of the mileage of the vehicle, which may be provided to a potential seller.

As illustrated in FIG. 4, the alert creation interface 402 may also include a link 410 to create an account for the seller. The account may be used to view sales leads of buyers, update alert information, and so on.

FIG. 5 illustrates an example search interface 502 to enable sellers to search through sales leads. The search interface 502 includes drop down menus 504 to select search input regarding details of a vehicle. The vehicle acquisition service 106 may utilize the search input to identify potential buyers that satisfy the search input. As illustrated, the search interface 502 may also include an input field 506 to input free-form text, instead of utilizing the drop down menus 504. Whether using the drop down menus 504 or the input field 506, the seller may select a button 508 to initiate a search through sales leads.

FIG. 6 illustrates an example seller alert interface 602 to notify a seller about a sales lead regarding a vehicle that is associated with the seller. The seller alert interface 602 may include a list of sales leads that satisfy alert information (e.g., provided via the alert creation interface 402 of FIG. 4) and/or search input (e.g., provided via the search interface 502 of FIG. 5). In this example, the seller has requested to identify sales leads for a 2004 Acura MDX with 64,000 miles that the seller is currently offering for acquisition for $14,500, as illustrated by seller information 604. The seller information 604 may be based on the alert information for the seller and may allow the seller to compare the vehicle that the seller is selling to sales leads of buyers. In one example, the seller alert interface 602 is provided via a mobile interface or web page.

The list of sales leads in the seller alert interface 602 includes a sales lead 606 for Buyer A and a sales lead 608 for Buyer C. Although any number of sales leads may be provided. The sales lead 606 includes details 610 about a vehicle that the buyer is seeking to acquire (e.g., make, model, mileage requested, etc.). Since a buyer of the sales lead 606 has allowed a potential seller to view contact information, the sales lead 606 also includes a link 612 to show contact information for the buyer. The sales lead 606 also includes other information 614 about the sales lead, such as a lead age (indicating a length of time that the sales lead has been active) and a number of lead purchases (e.g., a number of times the buyer has been contacted to offer a vehicle for acquisition to the buyer). Other information besides the information 614 may also be provided, such as a lead expiration time (e.g., this sales lead expires at 1 PM on Wednesday). Meanwhile, the sales lead 608 similarly includes details about a vehicle that a buyer is seeking and other information about the sales lead in general. The sales lead 608 does not, however, include a link to view contact information for the buyer, since this buyer has specified that no contact information is to be made available.

If the seller is interested is offering a vehicle for acquisition to the buyer, the seller may select the sales lead 606 or the sales lead 608 and notify the buyer. Details about the seller's vehicle (e.g., the seller information 604 or any details in alert information of the seller) may then be provided to the buyer. The buyer may be notified via an email, text message, etc. and/or an interface (e.g., the buyer notification interface 302 of FIG. 3). In some instances, the seller may also provide a message to the buyer (e.g., “I'm very motivated to sell my vehicle. I have to move this week.”).

In some examples, the seller may be required to submit payment to view contact information for the buyer (e.g., via the link 612) and/or to notify the buyer (e.g., by selecting one of the sales leads 606 or 608). In these examples, the seller may be prompted for billing information upon selecting a sales lead or link through the seller alert interface 602. Further, in some examples the seller may be required to provide vehicle identification information (e.g., a VIN) so that the vehicle acquisition service 106 may confirm that the seller is in possession of a vehicle that satisfies the buyer's request (e.g., a vehicle type described in buyer vehicle information).

### Example Processes

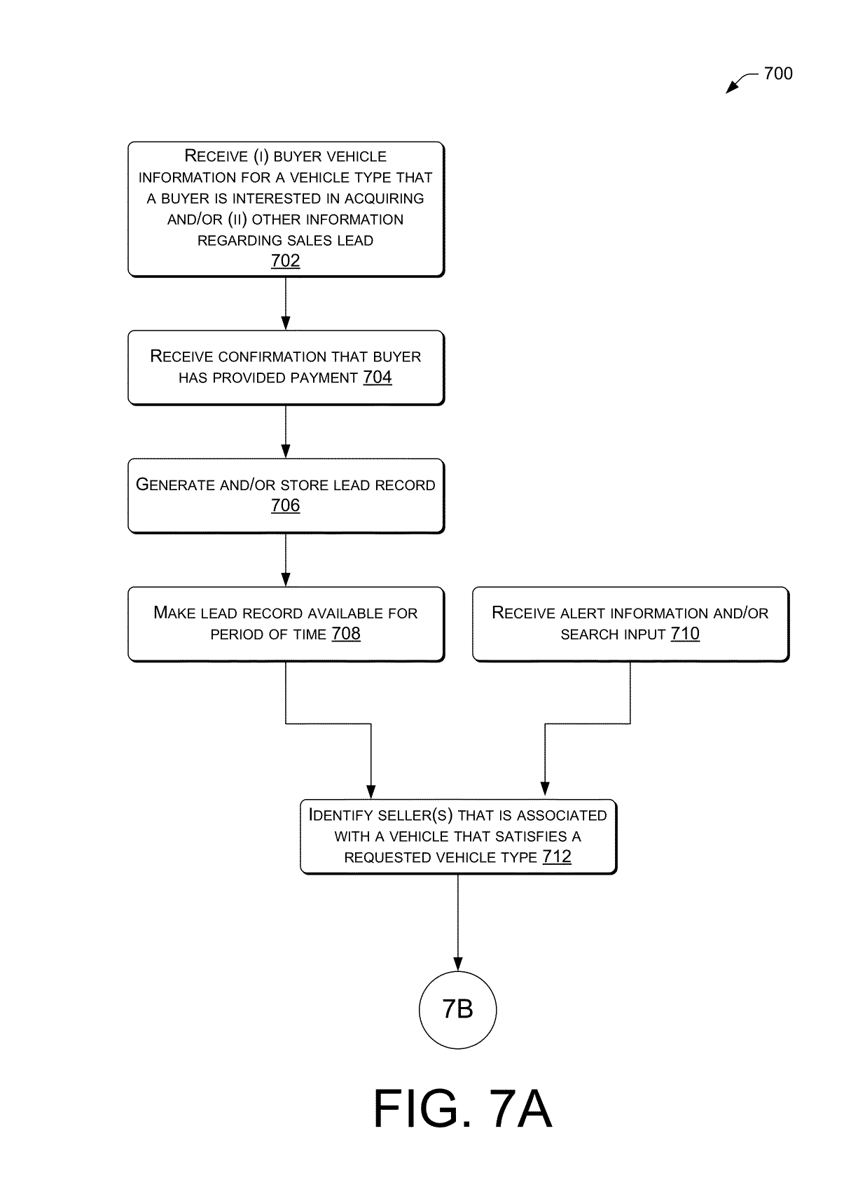

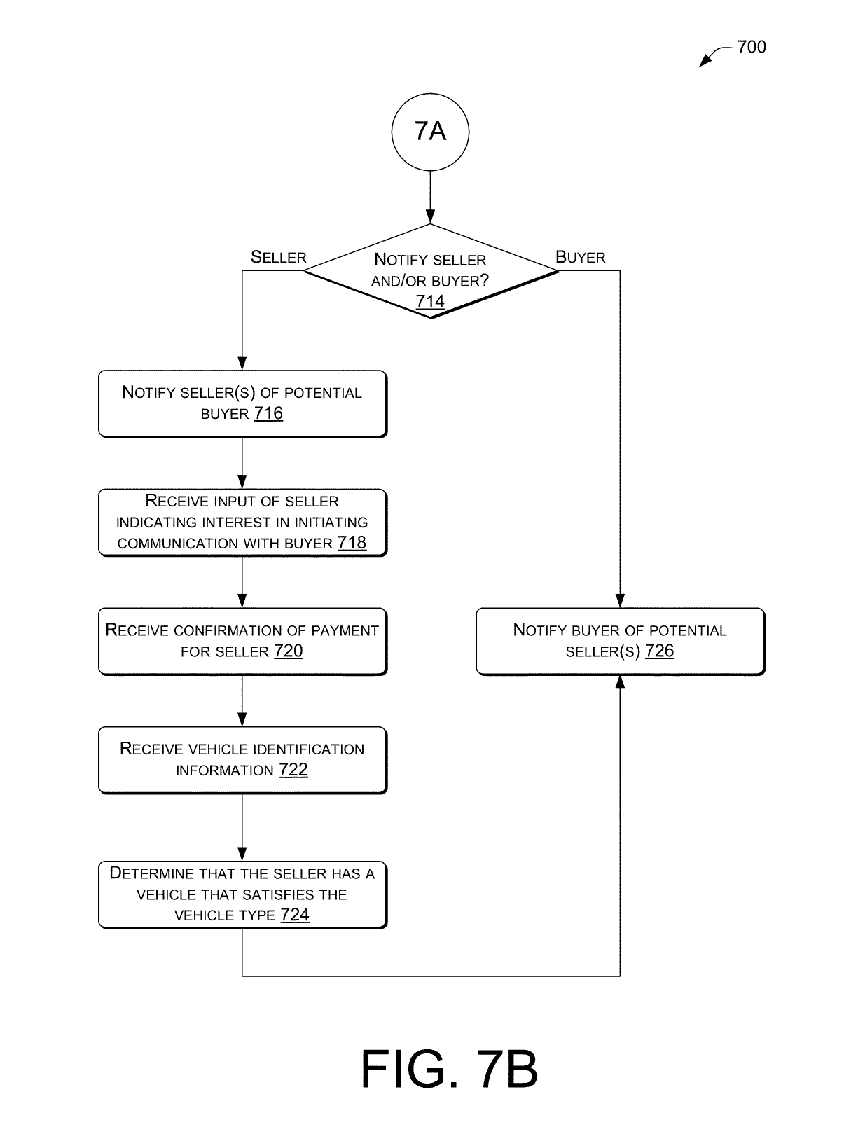

FIGS. 7A-7B illustrate an example process 700 for employing the techniques described herein. For ease of illustration the process 700 is described as being performed in the architecture 100 of FIG. 1. For example, one or more of the individual operations of the process 700 may be performed by the vehicle acquisition service 106, the buyer device 102, and/or the seller device 104. However, the process 700 may be performed in other architectures. Moreover, the architecture 100 may be used to perform other processes.

The process 700 (as well as each process described herein) is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the individual operations may be omitted.

In FIG. 7A, at 702, the vehicle acquisition service 106 may receive buyer vehicle information and/or other information regarding a sales lead. The buyer vehicle information may describe a type of vehicle that a buyer is interested in acquiring. For example, the buyer vehicle information may indicate a model of a vehicle, a manufacturer of a vehicle, a color of a vehicle, engine details of a vehicle, one or more years of a vehicle, a price range of a vehicle, mileage of a vehicle, and so on. The other information regarding the sales lead may indicate (i) a communication channel to utilize to notify the buyer about potential sellers, such as email, telephone, text message, an interface (e.g., web interface, mobile application interface, etc.), and so on, and/or (ii) an amount of information about the buyer that may be provided to a potential seller.

At 704, the vehicle acquisition service 106 may receive confirmation that the buyer has provided payment to request information related to acquiring a vehicle of the vehicle type (e.g., payment for utilizing the vehicle acquisition service 106). In some examples, the confirmation is received from a payment service, such as a bank service, online money transfer service, etc. If confirmation is not received regarding payment from the buyer, the vehicle acquisition service 106 may not proceed to perform other operations of the process 700.

At 706, the vehicle acquisition service 106 may generate and/or store a lead record for the buyer. The lead record may be generated based on the buyer vehicle information and/or other information regarding a sales lead. The lead record may represent a sales lead for the buyer.

At 708, the vehicle acquisition service may make a lead record available for a period of time, such as a predetermined period of time. This may include setting the lead record to an active state in which the lead record may be utilized to identify acquisition opportunities. In some instances, the period of time is based on an amount of payment that is received from the buyer (e.g., as the amount of payment increases, the period of time increases).

At 710, the vehicle acquisition service may receive alert information and/or search input. The alert information may describe a sales lead about which a seller is interested in being notified. The alert information may represent seller vehicle information in some instances. The search input may request a search through sales leads to identify potential buyers for a vehicle. The alert information and/or search input may identify a vehicle that the seller is offering for acquisition.

At 712, the vehicle acquisition service may identify a seller(s) that is associated with a vehicle that satisfies a requested vehicle type. A seller(s) may be identified based on a lead record (e.g., buyer vehicle information of the lead record), alert information of a seller, and/or search input of a seller. In one example, a seller may be identified that has a vehicle that matches completely a type of vehicle that is requested by the buyer (e.g., the seller's vehicle matches all characteristics of a vehicle that is requested by the buyer). In another example, a seller may be identified that has a vehicle that matches a particular number of characteristics of a vehicle that is requested by the buyer (e.g., a 90% match—a seller with a vehicle having 100,005 miles is identified for a request from a buyer for a vehicle with less than 100,000 miles, since the other characteristics of the seller's vehicle match the request from the buyer). In yet further examples, a seller may be identified through other techniques.

In FIG. 7B, at 714, the vehicle acquisition service 106 may determine whether to notify a seller and/or a buyer about an acquisition opportunity. In some instances, a buyer may request to be notified about a potential seller without the seller being notified. In other instances, the vehicle acquisition service 106 may be configured (based on seller and/or buyer input) to notify a seller about a potential buyer. In yet further instances, the vehicle acquisition service 106 may be configured to notify both a buyer and a seller.

At 716, the vehicle acquisition service 106 may notify a seller(s) about a potential buyer for a vehicle associated with the seller(s). This may include sending an email, sending a text message, initiating a telephone call, providing an alert via a mobile interface, providing an alert via a web page, and so on. In one example, a notification is made available to a seller regarding an opportunity for acquiring a vehicle of a vehicle type that is desired by a buyer. Further, in some examples other information may be provided to a seller about a sales lead, such as how recently a sales lead was generated or a number of times that payment has been provided to communicate with a buyer.

At 718, the vehicle acquisition service 106 may receive input of a seller indicating an interest in initiating communication with a buyer. The input may be provided via an interface, such as a seller alert interface.

At 720, the vehicle acquisition service 106 may receive confirmation that a seller has provided payment to initiate communication with a buyer. As noted above, in some instances a seller may be required to provide payment to communicate with a buyer about a potential vehicle acquisition. In some examples, the confirmation is received from a payment service, such as a bank service, online money transfer service, etc. If confirmation is not received regarding payment from the seller, the vehicle acquisition service 106 may not proceed to perform other operations of the process 700.

At 722, the vehicle acquisition service 106 may receive vehicle identification information for a vehicle that is associated with a seller. The vehicle identification information may comprise any type of information that identifies a vehicle, such as a VIN.

At 724, the vehicle acquisition service 106 may determine that a seller is in possession of a vehicle that satisfies a vehicle type that is desired by a buyer. The determination may be based on the vehicle identification information received at 722. In some instances, the vehicle acquisition service 106 may not proceed to perform other operations of the process 700 unless it is determined that the seller is in possession of a vehicle that satisfies a vehicle type that is desired by a buyer.

At 726, the vehicle acquisition service 106 may notify a buyer of a potential seller(s). This may include sending an email, sending a text message, initiating a telephone call, providing an alert via a mobile interface, providing an alert via a web page, and so on. In one example, a notification is made available to a buyer via an interface regarding an opportunity for acquiring a vehicle that is desired by the buyer. In many instances, a notification is provided to a buyer via a communication channel that has been previously selected by the buyer.

### Example Embodiments

Embodiment A, a method comprising: receiving, by a computing device, alert information describing a sales lead about which a seller is interested in being notified; receiving, by the computing device, buyer vehicle information describing a type of vehicle that a buyer is interested in acquiring; generating, by the computing device, a lead record for the buyer from the buyer vehicle information; making the lead record available for a predetermined period of time; based at least in part on the alert information and the lead record, determining that the buyer satisfies the sales lead about which the seller is interested in being notified; during the predetermined period of time and by the computing device: sending a notification about a potential buyer to a device of the seller; receiving seller input indicating an interest in offering a vehicle for acquisition to the buyer; and in response to receiving the seller input, sending a notification about a potential seller to a device of the buyer.

Embodiment B, the method of embodiment A, further comprising: receiving confirmation that the seller has provided payment to initiate communication with the buyer; wherein the notification about the potential seller is sent to the device of the buyer upon receiving the confirmation.

Embodiment C, the method of embodiment A, further comprising: receiving confirmation that the buyer has provided payment to request information related to acquiring a vehicle of the vehicle type; wherein the lead record is made available upon receiving the confirmation.

Embodiment D, the method of embodiment A, further comprising: receiving buyer input specifying a communication channel to utilize to notify the buyer about a potential seller; and wherein the notification about the potential seller is sent via the communication channel.

Embodiment E, the method of embodiment A, wherein the notification about the potential buyer that is sent to the device of the seller indicates at least one of how recently the lead record was generated or a number of times that payment has been provided to communicate with the buyer.

Embodiment F, one or more non-transitory computer-readable media having computer-readable instructions thereon which, when executed by one or more processors, cause the one or more processors to perform operations comprising: receiving buyer vehicle information describing a vehicle type that a buyer is interested in acquiring; identifying a seller that is associated with a vehicle that satisfies the vehicle type based at least in part on the buyer vehicle information; making information about a potential buyer available to a device of the seller; receiving seller input indicating an interest in initiating communication with the buyer; and based at least in part on the seller input, enabling at least one of (i) the buyer to contact the seller or (ii) the seller to contact the buyer.

Embodiment G, the one or more non-transitory computer-readable media of embodiment F, wherein the operations further comprise: receiving confirmation that the seller has provided payment to initiate communication with the buyer; and wherein the enabling is performed in response to receiving the confirmation.

Embodiment H, the one or more non-transitory computer-readable media of embodiment F, wherein the operations further comprise: receiving vehicle identification information for the vehicle that is associated with the seller; and determining that the seller is in possession of the vehicle that satisfies the vehicle type based at least in part on the vehicle identification information.

Embodiment I, the one or more non-transitory computer-readable media of embodiment F, wherein the vehicle type described in the buyer vehicle information is defined by at least one of: a model of a vehicle that the buyer is interested in acquiring; a manufacturer of a vehicle that the buyer is interested in acquiring; a color of a vehicle that the buyer is interested in acquiring; engine details of a vehicle that the buyer is interested in acquiring; one or more years of a vehicle that the buyer is interested in acquiring; a price range of a vehicle that the buyer is interested in acquiring; or mileage of a vehicle that the buyer is interested in acquiring.

Embodiment J, the one or more non-transitory computer-readable media of embodiment F, wherein the operations further comprise: receiving seller search input regarding a search through potential buyers; wherein the identifying the seller comprises determining that the seller is associated with the vehicle that satisfies the vehicle type based at least in part on the buyer vehicle information and the seller search input.

Embodiment K, the one or more non-transitory computer-readable media of embodiment F, wherein the operations further comprise: receiving seller vehicle information describing a vehicle that the seller is offering for acquisition; wherein the identifying the seller comprises determining, based at least in part on the seller vehicle information and the buyer vehicle information, that the vehicle that is being offered for acquisition by the seller satisfies the vehicle type that the buyer is interested in acquiring.

Embodiment L, the one or more non-transitory computer-readable media of embodiment F, wherein the enabling comprises providing contact information to at least one of the buyer or the seller by: sending an email; sending a text message; initiating a telephone call; providing an alert via a mobile interface; and/or providing an alert via a web page.

Embodiment M, a system comprising: one or more processors; memory communicatively coupled to the one or more processors; a buyer interface module stored in the memory and executable by the one or more processors to provide a buyer interface that enables a buyer to specify a desired vehicle type for acquisition; a lead record module stored in the memory and executable by the one or more processors to: generate a lead record for the buyer based at least in part on the desired vehicle type; and identify a seller that is associated with a vehicle that satisfies the desired vehicle type; a seller interface module stored in the memory and executable by the one or more processors to provide a seller interface that (i) presents information about the lead record to a seller and (ii) receives input from the seller indicating an interest in initiating communication with the buyer; and a notification module stored in the memory and executable by the one or more processors to make a notification available to at least one of the seller or the buyer, the notification regarding an opportunity for acquisition of the vehicle that satisfies the desired vehicle type.

Embodiment N, the system of embodiment M, wherein the information about the lead record that is presented via the seller interface indicates that the vehicle that satisfies the desired vehicle type is being requested for acquisition.

Embodiment O, the system of embodiment M, wherein the seller interface module is further configured to receive alert information describing one or more lead records about which a seller is interested in being notified.

Embodiment P, the system of embodiment M, wherein the information about the lead record that is presented via the seller interface indicates at least one of how recently the lead record was generated or a number of times that payment has been provided to communicate with the buyer.

Embodiment Q, the system of embodiment M, wherein the buyer interface module is further configured to receive input regarding payment from the buyer for information about sellers that are offering for acquisition a vehicle that satisfies the vehicle type.

Embodiment R, the system of embodiment M, wherein the seller interface module is further configured to receive input regarding payment from the seller for initiating communication with the buyer.

Embodiment S, the system of embodiment M, wherein the buyer interface presents information indicating that the seller is offering for acquisition a vehicle that satisfies the desired vehicle type, the information being based at least in part on the input from the seller indicating the interest in initiating communication with the buyer.

Embodiment T, the system of embodiment M, wherein the lead record module is configured to make the lead record available for a period of time that is based at least in part on an amount of payment that is received from the buyer.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method comprising:
receiving, by a computing device, alert information describing a sales lead about which a seller is interested in being notified;
receiving, by the computing device, buyer vehicle information describing a type of vehicle that a buyer is interested in acquiring;
generating, by the computing device, a lead record for the buyer from the buyer vehicle information;
making the lead record available for a predetermined period of time;
based at least in part on the alert information and the lead record, determining that the buyer satisfies the sales lead about which the seller is interested in being notified;
during the predetermined period of time and by the computing device:
sending a notification about a potential buyer to a device of the seller;
receiving seller input indicating an interest in offering a vehicle for acquisition to the buyer; and
in response to receiving the seller input, sending a notification about a potential seller to a device of the buyer.

2. The method of claim 1, further comprising:
receiving confirmation that the seller has provided payment to initiate communication with the buyer;
wherein the notification about the potential seller is sent to the device of the buyer upon receiving the confirmation.

3. The method of claim 1, further comprising:
receiving confirmation that the buyer has provided payment to request information related to acquiring a vehicle of the vehicle type;
wherein the lead record is made available upon receiving the confirmation.

4. The method of claim 1, further comprising:
receiving buyer input specifying a communication channel to utilize to notify the buyer about a potential seller; and
wherein the notification about the potential seller is sent via the communication channel.

5. The method of claim 1, wherein the notification about the potential buyer that is sent to the device of the seller indicates at least one of how recently the lead record was generated or a number of times that payment has been provided to communicate with the buyer.

6. One or more non-transitory computer-readable media having computer-readable instructions thereon which, when executed by one or more processors, cause the one or more processors to perform operations comprising:
receiving buyer vehicle information describing a vehicle type that a buyer is interested in acquiring;
identifying a seller that is associated with a vehicle that satisfies the vehicle type based at least in part on the buyer vehicle information;
making information about a potential buyer available to a device of the seller;
receiving seller input indicating an interest in initiating communication with the buyer; and
based at least in part on the seller input, enabling at least one of (i) the buyer to contact the seller or (ii) the seller to contact the buyer.

7. The one or more non-transitory computer-readable media of claim 6, wherein the operations further comprise:
receiving confirmation that the seller has provided payment to initiate communication with the buyer; and
wherein the enabling is performed in response to receiving the confirmation.

8. The one or more non-transitory computer-readable media of claim 6, wherein the operations further comprise:
receiving vehicle identification information for the vehicle that is associated with the seller; and
determining that the seller is in possession of the vehicle that satisfies the vehicle type based at least in part on the vehicle identification information.

9. The one or more non-transitory computer-readable media of claim 6, wherein the vehicle type described in the buyer vehicle information is defined by at least one of:
a model of a vehicle that the buyer is interested in acquiring;
a manufacturer of a vehicle that the buyer is interested in acquiring;
a color of a vehicle that the buyer is interested in acquiring;
engine details of a vehicle that the buyer is interested in acquiring;
one or more years of a vehicle that the buyer is interested in acquiring;
a price range of a vehicle that the buyer is interested in acquiring; or
mileage of a vehicle that the buyer is interested in acquiring.

10. The one or more non-transitory computer-readable media of claim 6, wherein the operations further comprise:
receiving seller search input regarding a search through potential buyers;
wherein the identifying the seller comprises determining that the seller is associated with the vehicle that satisfies the vehicle type based at least in part on the buyer vehicle information and the seller search input.

11. The one or more non-transitory computer-readable media of claim 6, wherein the operations further comprise:
receiving seller vehicle information describing a vehicle that the seller is offering for acquisition;
wherein the identifying the seller comprises determining, based at least in part on the seller vehicle information and the buyer vehicle information, that the vehicle that is being offered for acquisition by the seller satisfies the vehicle type that the buyer is interested in acquiring.

12. The one or more non-transitory computer-readable media of claim 6, wherein the enabling comprises providing contact information to at least one of the buyer or the seller by:
sending an email;
sending a text message;
initiating a telephone call;
providing an alert via a mobile interface; and/or
providing an alert via a web page.

13. A system comprising:
one or more processors;
memory communicatively coupled to the one or more processors;
a buyer interface module stored in the memory and executable by the one or more processors to provide a buyer interface that enables a buyer to specify a desired vehicle type for acquisition;
a lead record module stored in the memory and executable by the one or more processors to:
generate a lead record for the buyer based at least in part on the desired vehicle type; and
identify a seller that is associated with a vehicle that satisfies the desired vehicle type;
a seller interface module stored in the memory and executable by the one or more processors to provide a seller interface that (i) presents information about the lead record to a seller and (ii) receives input from the seller indicating an interest in initiating communication with the buyer; and
a notification module stored in the memory and executable by the one or more processors to make a notification available to at least one of the seller or the buyer, the notification regarding an opportunity for acquisition of the vehicle that satisfies the desired vehicle type.

14. The system of claim 13, wherein the information about the lead record that is presented via the seller interface indicates that the vehicle that satisfies the desired vehicle type is being requested for acquisition.

15. The system of claim 13, wherein the seller interface module is further configured to receive alert information describing one or more lead records about which a seller is interested in being notified.

16. The system of claim 13, wherein the information about the lead record that is presented via the seller interface indicates at least one of how recently the lead record was generated or a number of times that payment has been provided to communicate with the buyer.

17. The system of claim 13, wherein the buyer interface module is further configured to receive input regarding payment from the buyer for information about sellers that are offering for acquisition a vehicle that satisfies the vehicle type.

18. The system of claim 13, wherein the seller interface module is further configured to receive input regarding payment from the seller for initiating communication with the buyer.

19. The system of claim 13, wherein the buyer interface presents information indicating that the seller is offering for acquisition a vehicle that satisfies the desired vehicle type, the information being based at least in part on the input from the seller indicating the interest in initiating communication with the buyer.

20. The system of claim 13, wherein the lead record module is configured to make the lead record available for a period of time that is based at least in part on an amount of payment that is received from the buyer.
